(19) United States
(12) Patent Application Publication
(10) Pub. No.: US 2017/0058982 A1
(43) Pub. Date: Mar. 2, 2017

(54) BRAKE CORNER OUTPUT WITH FNC BRAKE ROTORS

(71) Applicant: GM Global Technology Operations LLC, Detroit, MI (US)

(72) Inventors: MICHAEL L. HOLLY, ST. CLAIR SHORES, MI (US); MARK T. RIEFE, BRIGHTON, MI (US); RICHARD A. KAATZ, MILFORD, MI (US); CARA L. LEARMAN, LINDEN, MI (US); DAVID B. ANTANAITIS, NORTHVILLE, MI (US); LISA G. DEVOE, ORTONVILLE, MI (US)

(21) Appl. No.: 14/835,918

(22) Filed: Aug. 26, 2015

(51) Int. Cl. F16D 69/02; C23C 8/32; C23C 8/80; F16D 65/12

(52) U.S. Cl. CPC F16D 69/02; F16D 65/127; F16D 65/125; C23C 8/32; C23C 8/80

(57) ABSTRACT

A number of variations may include a product that may include at least one working friction surface that may include at least two layers that may include a compound layer and a nitrogen diffusion layer wherein the compound layer may have a porosity ranging from about 19% to about 50%.

### TECHNICAL FIELD

The field to which the disclosure generally relates ferritic nitro-carburized (FNC) brake rotors.

### BACKGROUND

Motor vehicles having disc brake systems require high corrosion and wear resistance to increase the working life of disc brakes. Corrosion and wear resistance in brake rotors is commonly increased by ferritic nitro-carburizing of a cast iron brake rotor whereby a cast iron brake rotor is hardened by diffusing carbon and nitrogen into the brake rotor. A ferritically nitro-carburized rotational member of a vehicle brake has a friction surface configured for braking engagement with a corresponding friction material. A compound zone may be disposed at the friction surface. The compound zone may have a surface that is exposed to an atmosphere.

### SUMMARY OF ILLUSTRATIVE VARIATIONS

A number of variations may include a product that may include at least one working friction surface that may include at least two layers that may include a compound layer and a nitrogen diffusion layer wherein the compound layer may have a porosity ranging from about 19% to about 50%.

A number of variations may include a method that may include providing a part that may include a low alloy cast iron and at least one working friction surface and may further include nitro-carburizing the at least one working surface to provide at least two layers within the part that may include a compound layer and a nitrogen diffusion layer wherein the compound layer may have a porosity ranging from about 19% to about 50%.

A number of variations may include a product that may include a part that may include a low alloy cast iron and at least one working friction surface that may include at least two layers that may include a compound layer ranging from about 10 to about 20 microns in depth and that may include at least one of an e-carbonite phase, cementite, carbides, or nitrides and may have a porosity ranging from about 19% to about 50%

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a cross-section of a part including a compound layer and a nitrogen diffusion layer.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

A brake disc rotor or brake drum may be made of cast iron, low-carbon, low-alloy steels, or medium or high-carbon steels, and may be ferritic nitro-carburized. The FNC process may be accomplished via a number of different methods including gaseous, salt bath, ion or plasma, and fluidized-bed methods. The FNC process may diffuse carbon and nitrogen into ferrous metal at depths ranging from about 5 micrometers to about 400 micrometers. Two distinct zones or layers may be formed during the FNC process including a first compound zone ranging from about 5 micrometers to about 20 micrometers in thickness that may include an e-carbonite phase, cementite, carbides, and nitrides. A second diffusion zone may underlie the first compound zone and may range from about 350 micrometers to about 400 micrometers in thickness. The second diffusion zone may include nitrogen, iron oxides, and nitride needles. The porosity of the brake drum or brake disc rotor may range from about 19% to about 50% and furthermore may range from about 19% to about 30%. The surface roughness of the brake rotor may range from about a maximum of 1.2 Ra to about a maximum of 1.6 Ra where Ra is the arithmetic average of the roughness profile. In some instances, after the FNC process has been accomplished, further processing may be desirable. Disc brakes having one or two rotor cheeks with friction surfaces are known, for example, as shown in U.S. Pat. No. 7,975,750. Drum brakes with a friction surface are also known, for example, as shown in U.S. Pat. No. 8,210,232.

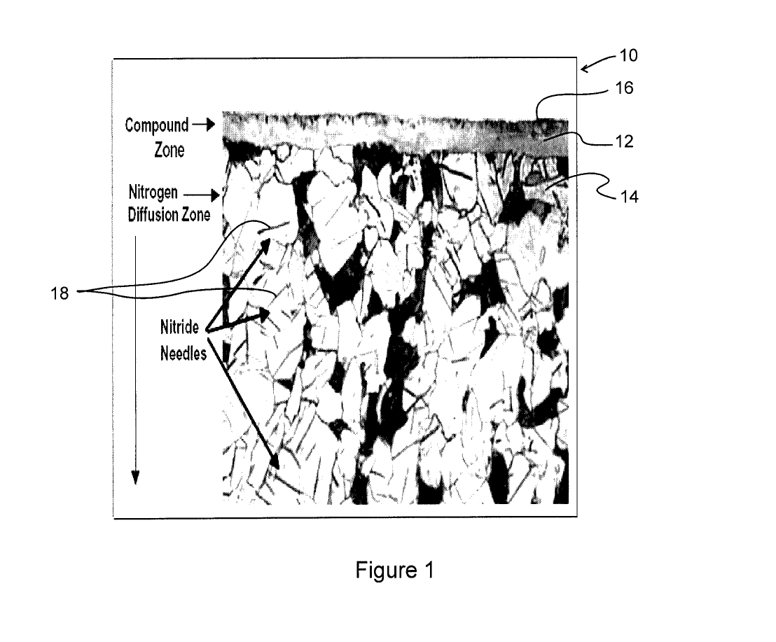

Referring to FIG. 1; a part 10 such as a brake drum or brake disc rotor may include a compound layer 12 having a working friction surface 16 disposed over a nitrogen diffusion layer 14.

A number of tests were performed and it was discovered that the apparent friction improves within a specific range of porosity of the compound layer, and also within a range of the depth or thickness of the compound layer as shown in Table 1 below.

TABLE 1

| Rotor Design (“Recipe”) | | | | | | Result | Improvement |
|---|---|---|---|---|---|---|---|
| | | | | | Rotor | Average | % Increase |
| | Cast | Compound | Compound | | Surface | Apparent | in avg AF |
| Sample | Iron | Zone | Zone | FNC | Finish | Friction | compared to |
| # | type | Depth | Porosity | Type | Type | (Avg AF) | Baseline |
| Baseline | G135 | 5 μm | 10% | Gray | Ground | 0.300972 | 0.0% |
| A | G205 | 11 μm | 19% | Blue | Turned | 0.311478 | 3.5% |
| B | G205 | 18 μm | 30% | Blue | Turned | 0.303662 | 0.9% |
| C | G205 | 20 μm | 50% | Blue | Turned | 0.306683 | 1.9% |
| D | G205 | 15 μm | 50% | Gray | Ground | 0.322443 | 7.1% |

The term “FNC Type—Gray” refers to a brake rotor that has undergone an after treat, occurring after the FNC process and subsequent strees relieving of the brake rotor, wherein the brake rotors are cooled in a protective atmosphere to 149 degrees C.; and the term “FNC Type—Blue” refers to a brake rotor that has undergone an after treat, occurring after the FNC process and subsequent strees relieving of the brake rotor, wherein the brake rotors are cooled in a protective atmosphere to 426 degrees C.

According to variation 1, a product may include at least one working friction surface that may include at least two layers that may include a compound layer and a nitrogen diffusion layer wherein the compound layer may have a porosity ranging from about 19% to about 50%.

Variation 2 may include a product as set forth in variation 1 wherein the working friction surface may include a low alloy cast iron.

Variation 3 may include a product as set forth in variation 1 or 2 wherein the compound layer may range from about 10 to about 20 microns in depth.

Variation 4 may include a product as set forth in any of variations 1 through 3 wherein the compound layer may include at least one of e-carbonite phase, cementite, carbides, or nitrides.

Variation 5 may include a product as set forth in any of variations 1 through 4 wherein the nitrogen diffusion layer may range from about 350 to about 400 microns in depth.

Variation 6 may include a product as set forth in any of variations 1 through 5 wherein the nitrogen diffusion layer may include nitrogen, iron oxides, and nitride needles.

Variation 7 may include a product as set forth in any of variations 1 through 6 wherein the compound layer may have a porosity of about 50%.

Variation 8 may include a product as set forth in any of variations 1 through 7 wherein the compound layer may have a porosity ranging from about 20% to about 30%.

Variation 9 may include a product as set forth in any of variations 1 through 8 wherein the working friction surface may have a surface finish roughness ranging from about a maximum of 1.2 Ra to about a maximum of 1.6 Ra.

Variation 10 may include a product as set forth in any of variations 1 through 9 wherein the product comprises a brake rotor having a rotor cheek wherein the working surface area is on the rotor cheek and further comprising second diffusion zone underlying the first compound zone and ranging from about 350 micrometers to about 400 micrometers in thickness.

According to Variation 11, a method may include providing a part that may include a low alloy cast iron and at least one working friction surface and may further include nitro-carburizing the at least one working surface to provide at least two layers within the part that may include a compound layer and a nitrogen diffusion layer wherein the compound layer may have a porosity ranging from about 19% to about 50%.

Variation 12 may include a method as set forth in variation 11 wherein the compound layer may range from about 10 to about 20 microns in depth.

Variation 13 may include a method as set forth in any of variations 11 through 12 wherein the compound layer may include at least one of an e-carbonite phase, cementite, carbides, or nitrides.

Variation 14 may include a method as set forth in any of variations 11 through 13 wherein the nitrogen diffusion layer may range from about 350 to about 400 microns in depth.

Variation 15 may include a method as set forth in any of variations 11 through 14 wherein the nitrogen diffusion layer may include nitrogen, iron oxides, and nitride needles.

Variation 16 may include a method as set forth in any of variations 11 through 15 wherein the compound layer may have a porosity of about 50%.

Variation 17 may include a method as set forth in any of variations 11 through 16 wherein the compound layer may have a porosity ranging from about 20% to about 30%.

Variation 18 may include a method as set forth in any of variations 11 through 17 wherein the working friction surface may have surface finish roughness ranging from about a maximum of 1.2 Ra to about a maximum of 1.6 Ra.

Variation 19 may include a method as set forth in any of variations 11 through 18 wherein the product comprises a brake rotor having a rotor cheek wherein the working surface area is on the rotor cheek and further comprising second diffusion zone underlying the first compound zone and ranging from about 350 micrometers to about 400 micrometers in thickness.

According to Variation 20, a product may include a part that may include a low alloy cast iron comprising G205 cast iron and at least one fine-turned working friction surface that may include at least two layers that may include a compound layer of about 15 microns in depth and that may include at least one of an e-carbonite phase, cementite, carbides, or nitrides and may have a porosity of about 50% and a nitrogen diffusion layer that may include nitrogen, iron oxides, and nitride needles.

The above description of variations within the scope of the invention is merely demonstrative in nature and, thus, variations thereof are not to be regarded as a departure from the spirit and scope of the inventions disclosed within this document.

1. A product comprising:
at least one working friction surface comprising at least two layers comprising a compound layer and a nitrogen diffusion layer wherein the compound layer has a porosity ranging from about 19% to about 50%.

2. A product as set forth in claim 1, wherein the working friction surface comprises a low alloy cast iron.

3. A product as set forth in claim 1, wherein the compound layer ranges from about 10 to about 20 microns in depth.

4. A product as set forth in claim 1, wherein the compound layer comprises at least one of e-carbonite phase, cementite, carbides, or nitrides.

5. A product as set forth in claim 1, wherein the nitrogen diffusion layer ranges from about 350 to about 400 microns in depth.

6. A product as set forth in claim 1, wherein the nitrogen diffusion layer comprises nitrogen, iron oxides, and nitride needles.

7. A product as set forth in claim 1, wherein the compound layer has a porosity of about 50%.

8. A product as set forth in claim 1, wherein the compound layer has a porosity ranging from about 30% to about 50%.

9. A product as set forth in claim 1, wherein the working friction surface has surface finish roughness ranging from about 1.2 Ra to about a maximum of 1.6 Ra.

10. A product as set forth in claim 1, wherein the product comprises a brake rotor having a rotor cheek wherein the working surface area is on the rotor cheek and further comprising second diffusion zone underlying the first compound zone and ranging from about 350 micrometers to about 400 micrometers in thickness.

11. A method comprising:
providing a part comprising a low alloy cast iron and at least one working friction surface;
nitro-carburizing the at least one working surface to provide at least two layers within the part comprising a compound layer and a nitrogen diffusion layer wherein the compound layer has a porosity ranging from about 19% to about 50%; and
fine turning the at least one working surface.

12. A method as set forth in claim 11, wherein the compound layer ranges from about 10 to about 20 microns in depth.

13. A method as set forth in claim 11, wherein the compound layer comprises at least one of an e-carbonite phase, cementite, carbides, or nitrides.

14. A method as set forth in claim 11, wherein the nitrogen diffusion layer ranges from about 350 to about 400 microns in depth.

15. A method as set forth in claim 11, wherein the nitrogen diffusion comprises nitrogen, iron oxides, and nitride needles.

16. A method as set forth in claim 11, wherein the compound layer has a porosity of about 50%.

17. A method as set forth in claim 11, wherein the compound layer has a porosity ranging from about 30% to about 50%.

18. A method as set forth in claim 11, wherein the working friction surface has surface finish roughness ranging from about 1.2 Ra to about a maximum of 1.6 Ra.

19. A method as set forth in claim 11, wherein the product comprises a brake rotor having a rotor cheek wherein the working surface area is on the rotor cheek and further comprising second diffusion zone underlying the first compound zone and ranging from about 350 micrometers to about 400 micrometers in thickness.

20. A product comprising:
a part comprising a low alloy cast iron comprising G205 cast iron and at least one fine-turned working friction surface comprising at least two layers comprising a compound layer of about 15 microns in depth comprising at least one of an e-carbonite phase, cementite, carbides, or nitrides and having a porosity of about 50% and a nitrogen diffusion layer comprising nitrogen, iron oxides, and nitride needles.
